(19) United States
(12) Patent Application Publication
(10) Pub. No.: US 2026/0338430 A1
(43) Pub. Date: Oct. 29, 2026

(54) ARRANGEMENT FOR A TEMPERATURE-CONTROL CIRCUIT

(71) Applicant: TI Automotive Technology Center GmbH, Rastatt (DE)

(72) Inventors: Sebastian BRIXNER, Edingen-Neckarhausen (DE); Werner MERZ, Gaggenau (DE); Gerhard KOLB, St. Leon-Rot (DE); Christian HENNING, Kehl (DE)

(21) Appl. No.: 19/104,879

(22) PCT Filed: Aug. 9, 2023
(86) PCT No.: PCT/EP2023/072050

§ 371 Date: Feb. 19, 2025

(30) Foreign Application Priority Data
Aug. 19, 2022 (EP) 22191245.4

(51) Int. Cl. F25B 41/20; F25B 9/00

(52) U.S. Cl. CPC F25B 41/20; F25B 9/008; F25B 2309/06

(57) ABSTRACT

An arrangement for a temperature control circuit having a base body, in which at least one channel for the transport of temperature control medium is introduced, and at least one check valve, which at least limits the transport of temperature control medium in one flow direction of the channel. The check valve is formed as an insert and is at least partially accommodated in the base body.

### RELATED APPLICATIONS

The present disclosure claims priority to and is a national phase application of PCT Application PCT/IB2023/072050, filed Aug. 9, 2023, which claims priority to European Application 22191245.4, filed Aug. 19, 2022, the entire contents of which are incorporated herein by reference.

### FIELD

The disclosure relates to an arrangement for a temperature control circuit, comprising a base body, in which at least one channel for the transport of temperature control medium is introduced, and at least one check valve, which at least limits the transport of temperature control medium in one flow direction of the channel.

### BACKGROUND

From the state of the art, arrangements for a cooling device are known, in which check valves are integrated into a temperature control medium circuit in such a way that, depending on the flow direction of the temperature control medium, temperature control medium flows through different components of the temperature control medium circuit.

In principle, temperature control medium flows are used in a plurality of applications where it is necessary to control the temperature of a device and, in doing so, either heat or cool it, depending on the requirements. This applies in particular to electric vehicles, where the longest possible range is to be achieved. This requires electrical components to be temperature-controlled. The components whose temperature needs to be controlled are, in particular, electrical energy storage units, but also the power electronics or connectors of fast-charging devices. An electrical energy storage device has a best possible capacity only in a very small temperature spectrum. Therefore, it is necessary to heat electrical energy storage devices of electric vehicles at low ambient temperatures and to cool them at high outside temperatures or during high load changes. Another essential aspect relates to the air conditioning of a vehicle interior, which is air-conditioned with a temperature control device in form of an air conditioning system.

For this purpose, it is known to provide a temperature control circuit through which a temperature control medium flows. Depending on the requirements, the temperature control medium can either be heated in a heating device or cooled in a cooling device. In doing so, the temperature control medium flow can be controlled via solenoid valves. However, it is also known to control temperature control medium flows using check valves, wherein the check valves are integrated into the temperature control circuit in form of separate components.

Temperature control, in particular cooling, can then take place by means of a coolant circuit in which a temperature control medium in form of a refrigerant, for example CO2 or a halogenated hydrocarbon, circulates. With a refrigerant circuit based on CO2 (R744) as a refrigerant, the system pressure of 170 bar inside the circuit is high. The temperatures of the refrigerant range between −30 °C and 100 °C.

### SUMMARY

The present disclosure provides an arrangement for a cooling device that is cost-effective and compact.

The arrangement for a temperature control circuit according to the disclosure comprises a base body, in which at least one channel for the transport of temperature control medium is introduced, and at least one check valve, which at least limits the transport of temperature control medium in one flow direction of the channel, wherein the check valve is formed as an insert and is at least partially accommodated in the base body.

Accordingly, the at least one check valve is at least partially integrated into the base body, resulting in a particularly compact arrangement. Moreover, due to the direct integration of the check valve into the base body, additional line connections between the base body and the check valve, such as hoses, pipes or similar, can be omitted, depending on the embodiment. Due to the fact that the check valve is formed as an insert, the check valve is accommodated in the base body in a removable manner. This allows individual components of the arrangement to be replaced.

The base body can be formed as a distribution channel. A distribution channel of a ring circuit is used to distribute the temperature control medium. According to an advantageous embodiment, the temperature control circuit is formed as a refrigerant circuit. In this case, the temperature control medium is a refrigerant, wherein the arrangement according to the disclosure is particularly suitable for the use of CO2 (R744) as a refrigerant. The distribution channel has at least one channel. According to an advantageous embodiment, the distribution channel has multiple channels, so that the control of different components of the refrigerant circuit is particularly simple and cost-effective. In addition, the base body allows forming a particularly compact arrangement. The base body is preferably made of metallic material, wherein it is also conceivable in principle to make the base body from plastic. The channels can open into inlets or outlets and the inlets and outlets can be equipped for accommodating pipes with further base bodies or further components of a temperature control circuit. In case of a block-shaped embodiment of the base body, a particularly compact embodiment of the arrangement is achieved. The base body can have multiple channels and multiple check valves.

The check valve limits the flow of temperature control medium in one direction or prevents the flow of temperature control medium in one direction. If the arrangement has multiple channels, check valves can be introduced into the arrangement in such a way that, depending on the flow direction, only certain channels are flowed through by the temperature control medium. In other channels, the temperature control medium flow is blocked by the check valve. Accordingly, different components connected to the arrangement can be temperature-controlled depending on the flow direction of the temperature control medium. Here, components are not only devices to be temperature-controlled, but also devices that bring the temperature control medium to a specified temperature, i.e., heat or cool it.

The check valve can have a sleeve, a piston and a fastening section, wherein at least one opening is introduced in the sleeve on the circumferential side, wherein the sleeve has an opening on the end face facing away from the fastening section, wherein the piston is allocated to the opening. The side of the piston facing the opening can be shaped like a stamp or ball and blocks a flow of temperature control medium via the opening in one flow direction. Preferably, the embodiment is formed, so that temperature control medium can flow into the sleeve via the opening on the end face side whereas temperature control medium flowing via the sleeve in the direction of the opening is blocked. In this case, the piston presses against the opening and prevents the temperature control medium from flowing out. In doing so, a spring means can be allocated to the piston, wherein the spring means presses the piston against the circumferential edge of the opening with elastic preload.

Multiple circumferential openings can be introduced in the sleeve. Temperature control medium can flow out of the sleeve via the circumferential openings.

The sleeve protects the piston of the check valve and allows particularly easy mounting and integration of the check valve into the arrangement. Furthermore, the check valve consisting of sleeve and piston is particularly compact.

Preferably, the temperature control medium flows into the check valve via the end face opening and out via the circumferential opening.

An annular channel can be introduced in the base body, the annular channel being allocated to the circumferential openings. The annular channel extends around the openings and forms a collecting channel in which the temperature control medium can accumulate and be removed via a flow channel. Flow losses can be reduced thanks to the annular channel.

At least one anti-rotation device can be introduced into the fastening section and the base body respectively. Preferably, the anti-rotation device of the fastening section and the anti-rotation device of the base body work together to ensure that the check valve is mounted in the correct position in the arrangement. This is particularly advantageous if a correct positioning of the end face and/or circumferential openings relative to the flow channels is desired.

A conical receiving section for a pipe connection can be formed from the fastening section. The conical receiving section can form a clutch to which a pipe can be attached. With this embodiment, a local deformation of the pipe can occur, so that a particularly tight connection is created between the check valve and the pipe.

The fastening section can be equipped with a positioning aid. A positioning aid is particularly advantageous if the check valve is accommodated or integrated in the arrangement in such a way that it is not possible to rotate the check valve by simple means. Accordingly, the positioning aid allows the check valve to be mounted in the correct position in the arrangement by simple means. For this purpose, for example, a hole or projection or similar can be formed from the fastening section, so that the check valve can be rotated using a suitable tool.

An expansion valve can be allocated to the at least one channel. The expansion valve is part of a temperature control circuit and, due to the direct allocation of the expansion valve to a channel, the arrangement can be particularly compact.

A transverse channel can be provided which runs transversely to the sleeve. In particular, it is conceivable that the temperature control medium flows into the sleeve via a first circumferential opening and out of the sleeve via a second circumferential opening without the piston being actuated. The first opening can be opposite the second opening. Accordingly, the embodiment of a transverse channel allows the embodiment of a bypass through which temperature control medium can flow without a check valve being actuated. In addition to the transverse channel, the base body can have multiple channels, wherein a check valve is allocated to each channel. Due to the check valve, the temperature control medium can pass through the channels in one flow direction only while the temperature control medium can pass through the transverse channel in both flow directions.

An abutting section can be formed from the circumferential opening and/or the end face opening, wherein the cross-section of the abutting section widens outwards from the inside of the sleeve. Via the abutting section, a conduitelement, for example a pipe, can be connected to the check valve in a sealing manner. For this purpose, the conduitelement can be provided with a tubular section and a thickening that is formed at one end of the conduitelement. A connecting element can be pushed onto the conduitelement, which has a recess and accommodates the conduitelement in the recess in such a way that the connecting element is held on the conduitelement by means of the thickening in a form-fitting and loss-proof manner. The connecting element and the component can each have a thread, wherein the threads are engaged and form a threaded connection, wherein the thickening forms a contact section. The contact section can abut sealingly against the abutting section, so that the conduitelement is connected to the sleeve in a flow-conducting manner. The threaded connection presses the contact section against the abutting section by means of the form-fitting connection between the connecting element and the conduitelement. The abutting section can form a conical cross-section.

### BRIEF DESCRIPTION OF THE DRAWINGS

Some embodiments of the arrangement according to the disclosure are explained in more detail below with reference to the figures. These show, each schematically:

FIG. 1 an arrangement with an integrated check valve in section;

FIG. 2 an arrangement according to FIG. 1 with receiving sections for pipes, formed from the check valve;

FIG. 3 an arrangement with a check valve with a receiving section for a pipe;

FIG. 4 an arrangement according to FIG. 1 with multiple receiving sections for pipes;

FIG. 5 in detail, a check valve in section.

### DETAILED DESCRIPTION

The figures show an arrangement 1 for a temperature control circuit. The arrangement 1 forms part of a refrigerant circuit in an air conditioning system. The arrangement 1 comprises a base body 2 in which multiple channels 3 are introduced for the transport of temperature control medium. The temperature control medium is a refrigerant, specifically CO2. In this case, the base body 2 forms a distribution channel and feeds the refrigerant to the components of the refrigerant circuit.

Further, check valves 4 are provided, which block the transport of temperature control medium in one flow direction within the channels. The check valves 4 are formed as an insert and are accommodated in the base body 2. The check valves 4 are integrated into the arrangement 1 in such a way that temperature control medium flows can be modified, wherein different components of the temperature control circuit can be flowed through depending on the flow direction, whereas the temperature control medium flow is blocked in other flow channels by a check valve 4. This allows, for example, the circulation of the refrigerant to be modified, depending on the ambient temperature and power requirements. The modification of the temperature control medium flow occurs by means of the check valves 4 arranged in the base body 2. The components of the refrigerant circuit are connected directly to the base body 2. Depending on the installation space and arrangement of the components, the components can also be connected to the base body 2 via hoses or pipes. Components of the refrigerant circuit are in particular heat exchangers, evaporators, chillers, condensers, gas coolers, battery cooling plates, compressors and accumulators. These components can be selectively controlled using the arrangement 1. In the present embodiment, the base body 2 is made of aluminum.

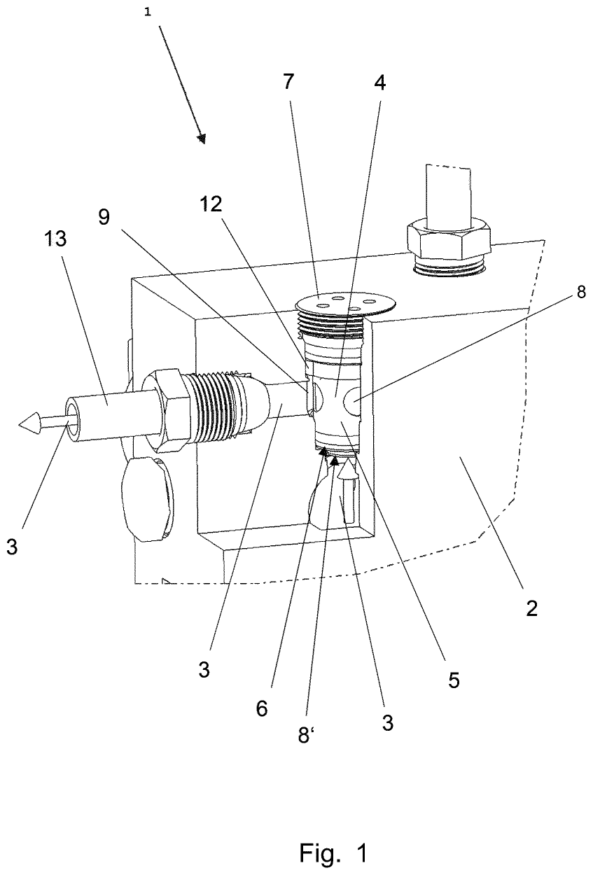

In the embodiment shown in FIG. 1, the check valve 4 is fully integrated into the base body 2 and is flush with the surface of the base body 2. For this purpose, a recess is introduced in the base body 2, the check valve 4 being arranged in the recess. The check valve 4 has a sleeve 5, a piston 6 arranged in the sleeve 5 and a fastening section 7, wherein multiple openings 8 are introduced in the sleeve 5 on the circumferential side, which are evenly distributed over the circumference of the sleeve 5. In this embodiment, the sleeve 5 and the fastening section 7 form two independent components. The sleeve 5 with the piston 6 accommodated therein is formed as an insert that is inserted into the recess. The fastening section 7 is formed as a screw cap and secures the sleeve 5 in the recess. A further opening 8′ is introduced in the sleeve 5 on the end face facing away from the fastening section 7, wherein the piston 6 is allocated to the opening 8′. The piston 6 is pressed against the inside of the further opening 8′ via a spring means. Via the opening 8′, the check valve 4 is connected to the channel 3 arranged on the inside of the base body 2 in a flow-conducting manner. The sleeve 5 and the fastening section 7 are made of steel in the present embodiment.

The temperature control medium flows through the inner channel 3 into the sleeve 5 via the opening 8′ on the end face side and out via the circumferential openings 8. In the reverse flow direction, the piston 6 that rests against the further opening 8′ blocks the temperature control medium, so that it cannot flow out via the further opening 8′.

An annular channel 9 is introduced in the base body 2, the annular channel being allocated to the circumferential openings 8 and forming a collecting channel that extends around the sleeve 5.

The fastening section 7 is equipped with a positioning aid 12. An anti-rotation device 12 is introduced into the fastening section 7 and into the base body 2 respectively, which ensures that the sleeve 5 of the check valve 4 is positioned correctly in the base body 2. The anti-rotation device 12 comprises a radial projection introduced into the outside of the sleeve 5, which engages in a congruent indentation introduced in the recess of the base body 2.

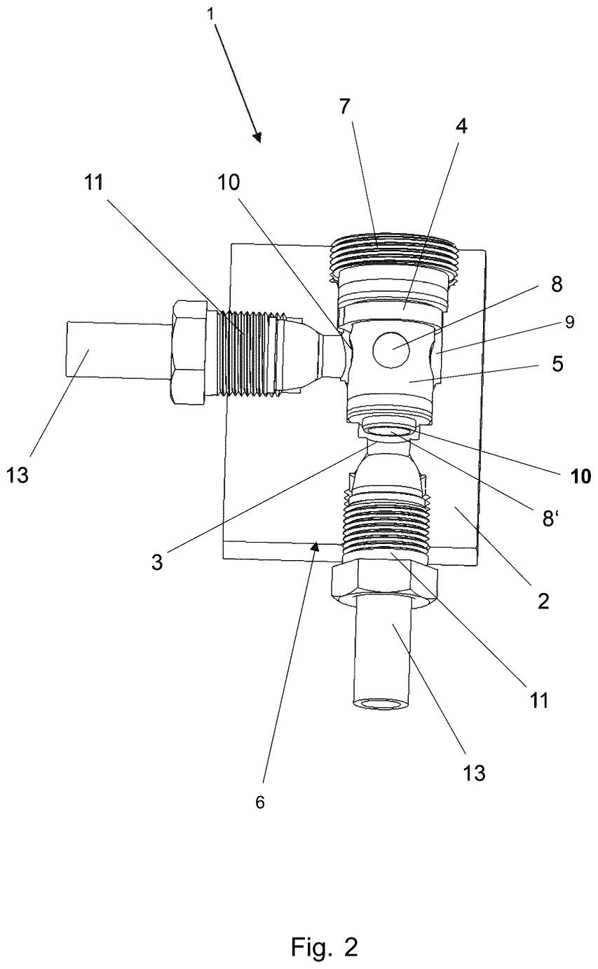

FIG. 2 shows a further development of the arrangement 1 shown in FIG. 1. In the present arrangement 1, the opening 8 and the further opening 8′ widen outwards from the inside of the sleeve 5 and are conical in shape. As a result, the opening 8 and the further opening 8′ form a receiving section 10 against which the thickened end of the pipe 13 rests in a sealing manner. The receiving section 10 is part of a pipe connection 11.

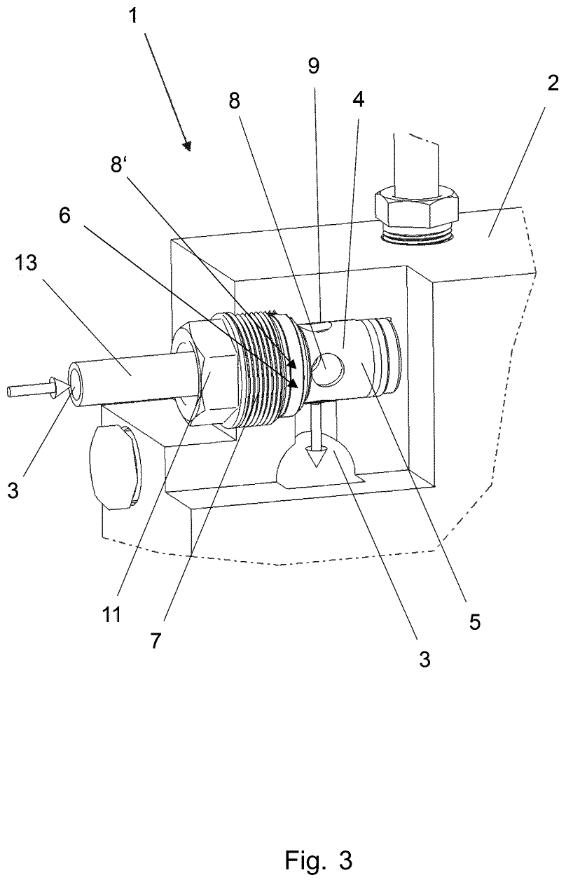

In the embodiment shown in FIG. 3, the check valve 4 is screwed into the base body, wherein a receiving section formed from the check valve 4 for connecting the check valve 4 to the pipe protrudes from the base body 2. The base body 2 has a recess in which the check valve 4 is partially accommodated. The check valve 4 has a sleeve 5, a piston 6 arranged in the sleeve 5 and a fastening section 7, wherein multiple openings 8 are introduced in the sleeve 5 on the circumferential side, which are evenly distributed over the circumference of the sleeve 5. The fastening section 7 and the recess of the base body 2 are provided with a thread.

On the side facing the fastening section 7, a further opening 8′ is introduced in the sleeve 5, wherein the piston 6 is allocated to the opening 8′. The further opening 8′ widens outwards from the inside of the sleeve 5 and is formed in a conical shape. As a result, the opening 8′ forms a receiving section 10 against which the thickened end of the pipe 13 rests in a sealing manner. The receiving section is part of a pipe connection 11.

The piston 6 is pressed against the inside of the further opening 8′ via a spring means. Via the opening 8′, the check valve 4 is connected to the channel 3 arranged on the inside of the base body 2 in a flow-conducting manner.

The temperature control medium flows through the inner channel 3 into the sleeve 5 via the opening 8′ on the end face side and out via the circumferential openings 8. In the reverse flow direction, the piston 6 that rests against the further opening 8′ blocks the temperature control medium, so that it cannot flow out via the further opening 8′.

An annular channel 9 is introduced in the base body 2, the annular channel being allocated to the circumferential openings 8 and forming a collecting channel that extends around the sleeve 5.

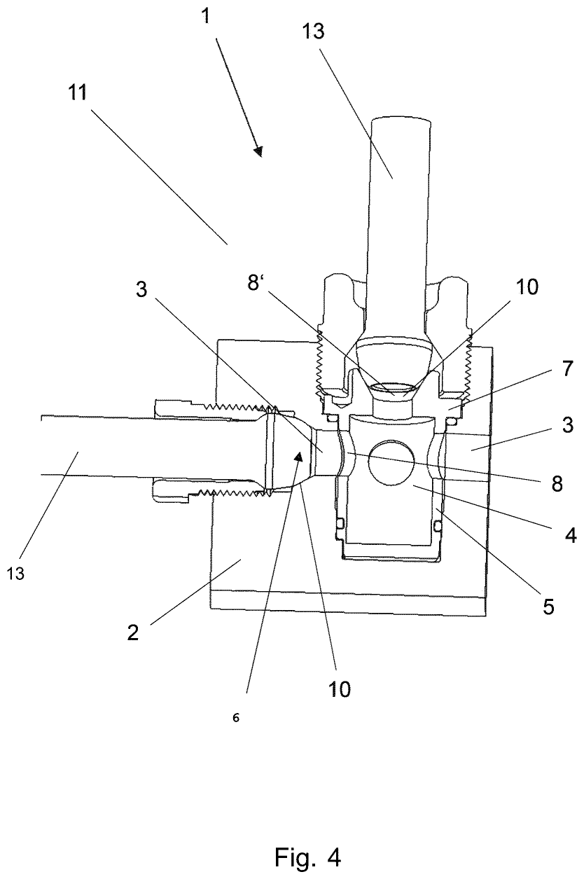

FIG. 4 shows a further development of the arrangement 1 shown in FIG. 2. In the present arrangement 1, the further opening 8′ widens outwards from the inside of the sleeve 5 and is formed in a conical shape. A further cross-sectional widening is formed from the channel 3 allocated to the opening 8. Accordingly, the cross-sectional widening allocated to the channel 3 is formed from the base body. The opening 8 and the cross-sectional widening formed from channel 3 form a receiving section 10 against which the thickened end of the pipe 13 rests in a sealing manner in each case. The receiving section 10 is part of a pipe connection 11 in each case.

The base body 2 shown in FIGS. 1 to 4 can be formed to accommodate multiple check valves 4. The base body 2 can form a pipe arrangement for a temperature control device. A transverse channel can be formed from the base body 2, the transverse channel running transversely to the check valves 4 and connecting the circumferential openings 8 of the check valves 4 to each other in a flow-conducting manner. The transverse channel can form a bypass. In this context, it can be seen in FIG. 4 that the channel 3 extends on both sides of the sleeve 5, so that the temperature control medium can flow through the sleeve 5 unhindered by the piston 6 and the check valve 4 in both flow directions.

An expansion valve can be allocated to one or more channels 3. In this context, it is particularly conceivable that the expansion valve is formed from the sleeve 5, in particular from one of the openings 8 of the check valve 4. The expansion valve forms an integral part of the check valve 4.

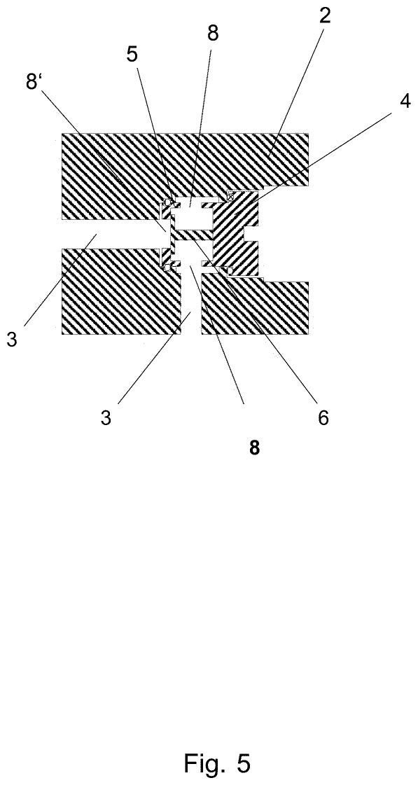

FIG. 5 shows in detail a check valve 4 of an arrangement 1 according to one of the previous figures. The check valve 4 has a sleeve 5, a piston 6 arranged in the sleeve 5 and a fastening section 7, wherein multiple openings 8 are introduced in the sleeve 5 on the circumferential side, which are evenly distributed over the circumference of the sleeve 5. A further opening 8′ is introduced in the sleeve 5 on the end face facing away from the fastening section 7, wherein the piston 6 is allocated to the opening 8′. The piston 6 is pressed against the inside of the further opening 8′ via a spring means.

1. An arrangement for a temperature control circuit, comprising a base body, in which at least one channel for the transport of temperature control medium is introduced, and at least one check valve, which at least limits the transport of temperature control medium in one flow direction of the channel, wherein the check valve is formed as an insert and is at least partially accommodated in the base body.

2. The arrangement according to claim 1, wherein the base body is formed as a distribution channel.

3. The arrangement according to claim 1, wherein the check valve has a sleeve, a piston and a fastening section, wherein at least one opening is introduced in the sleeve on the circumferential side, wherein the sleeve has a further opening on the end face facing away from the fastening section, wherein the piston is allocated to the further opening.

4. The arrangement according to claim 3, wherein multiple circumferential openings are introduced in the sleeve.

5. The arrangement according to claim 3, wherein temperature control medium flows in via the further opening and flows out via the circumferential opening.

6. The arrangement according to claim 3, wherein an annular channel is introduced in the base body, the annular channel being allocated to the circumferential openings.

7. The arrangement according to claim 3, wherein at least one anti-rotation device is introduced into the fastening section and into the base body respectively.

8. The arrangement according to claim 3, wherein a conical receiving section for a pipe connection is formed from the fastening section.

9. The arrangement according to claim 3, wherein the fastening section is equipped with a positioning aid.

10. The arrangement according to claim 1, wherein an expansion valve is allocated to at least one channel.

11. The arrangement according to claim 3, wherein a transverse channel is provided which runs transversely to the sleeve.

12. The arrangement according to claim 1, wherein the base body is formed of metallic material.

13. The arrangement according to claim 3, wherein the sleeve and the fastening section are formed of metallic material.

14. A temperature control circuit, comprising an arrangement configured according to claim 1.

15. The temperature control circuit according to claim 14, wherein the temperature control circuit is a cooling circuit and the temperature control medium is a refrigerant based on CO₂.
